(19) United States
(12) Patent Application Publication
(10) Pub. No.: US 2011/0295649 A1
(43) Pub. Date: Dec. 1, 2011

(54) AUTOMATIC CHURN PREDICTION

(75) Inventors: Shai Fine, Herzeliya (IL); Elad Yom-Tov, Mizpe Hoshaya (IL); Yossi Richter, Kfar Saba (IL)

(73) Assignee: International Business Machines Corporation, Armonk, NY (US)

(21) Appl. No.: 12/790,850

(22) Filed: May 31, 2010

(51) Int. Cl. G06Q 10/00; G06F 15/18; G06N 5/02; G06Q 50/00

(52) U.S. Cl. 705/7.29; 706/12; 706/52

(57) ABSTRACT

Churn prediction is performed by monitoring quality of service levels provided to customers. A time in which the customer is due to either churn or renew his agreement with the service provider may be monitored or computed. Machine learning methods may be utilized to determine a probability of churn based on historic data. Based upon the determination an output to retention personnel may be provided and an improved offer may be made to customers that are deemed in risk of churning.

### BACKGROUND

The present disclosure relates to automatic estimation of churn probability in general, and to automatic estimation of churn probabilities of customers of a communication service provider based on prior usage information in particular.

Many service providers, such as communication service providers in general, and mobile telecommunication service providers in particular, gather diverse statistical information about an individual customer in order to predict his behavior, needs, requirements and the like. In some cases, an estimation of a possibility that the customer will stop being a customer of the service provider, also referred to as churn, is established and based on that estimation preventive measurements are taken. Some exemplary preventive measurements are to offer the customer a discount, an upgrade of is the service and the like.

Churn prediction is significant for many service providers in order to continue growing and increase their profits, churn rate should be minimized as attracting new customers usually requires investing in promotional content, advertisements, marketing and the like.

Service quality is well known to affect customer loyalty and his propensity to churn. Quality of Service (QoS) usually measured through customer interactions with service representatives. Such measurements do not indicate actual QoS provided to the customer, rather quality as mirrored by the customer through the service representative.

### BRIEF SUMMARY

One exemplary embodiment of the disclosed subject matter is a computerized apparatus for estimating churn possibility, the computerized apparatus having a processor, the computerized apparatus comprising: a first receiver configured to receive an indication of Quality of Service based on a service provided to a customer by a service provider; a second receiver configured to receive an indication of a time in which the customer is estimated to either continue or discontinue receiving the service from the service provider; a Quality of Service level determinator configured to determine a Quality of Service level provided to the customer in a timeframe based on the indication received by the first receiver; a churn possibility determinator configured to determine a probability of churn associated with the customer based on the Quality of Service level determined by the Quality of Service level determinator and based on the time received by the second receiver; and an output module configured to provide an indication of the probability of churn determined by the churn possibility determinator.

Another exemplary embodiment of the disclosed subject matter is a computer-implemented method for estimating churn possibility, the method comprising: receiving an indication of Quality of Service based on a service provided to a customer by a service provider; receiving an indication of a time in which the customer is estimated to either continue or discontinue receiving the service from the service provider; determining a Quality of Service level provided to the customer in a timeframe based on the indication of Quality of Service; determining a probability of churn associated with the customer based on the Quality of Service level and based on the time in which the customer is estimated to either continue or discontinue receiving the service from the service provider; and outputting an indication of the probability of churn.

Yet another exemplary embodiment of the disclosed subject matter is a computer program product for estimating churn possibility, the product comprising: a computer readable medium; a first program instruction for receiving an indication of Quality of Service based on a service provided to a customer by a service provider; a second program instruction for receiving an indication of a time in which the customer is estimated to either continue or discontinue receiving the service from the service provider; a third program instruction for determining a Quality of Service level provided to the customer in a timeframe based on the indication of Quality of Service; a fourth program instruction for determining a probability of churn associated with the customer based on the Quality of Service level and based on the time in which the customer is estimated to either continue or discontinue receiving the service from the service provider; a fifth program instruction for outputting an indication of the probability of churn; and wherein the first, second, third, fourth and fifth program instructions are stored on the computer readable medium.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2 shows a block diagram of a churn estimator, in accordance with some exemplary embodiments of the disclosed subject matter;

FIG. 3 shows a flowchart diagram of a method, in accordance with some exemplary embodiments of the disclosed subject matter;

FIG. 4 shows two curves between days before waypoint and average QoS provided to customers, in accordance with the disclosed subject matter; and

FIG. 5 shows a curve exemplifying a lift in identifying customers that are about to churn using the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to estimate churn probability of a customer based on QoS level provided to the customer.

One technical solution is to track QoS level provided to the customer, such as for example failed calls in a telephone provider, an available bandwidth in a Internet Service Provider (ISP) or similar data service provider, or the like. Based upon tracked QoS level, a QoS level in a timeframe may be determined, such as based on a lowest QoS level, a median QoS level, an average QoS level, or the like. Another technical solution is to utilize machine learning techniques to automatically determine whether a customer is likely to churn, based on past data. Yet another technical solution is to generate a suggestion to contact a customer to extend his contract based on the tracked QoS data. The customer may be contacted to in a time such that the QoS level he received is above a threshold. A suggestion to provide a customer with an improved offer may be generated based on QoS level being below a threshold. The nature of the improved offer may differ based on the QoS level provided to the customer.

One technical effect of utilizing the disclosed subject matter is automatically segmenting customers into groups, based on churn probability. Another technical effect is to enable acting upon QoS information to increase business value for the service provider. Yet another technical effect is to transform records pertaining to QoS to indicate probability of churn of a customer.

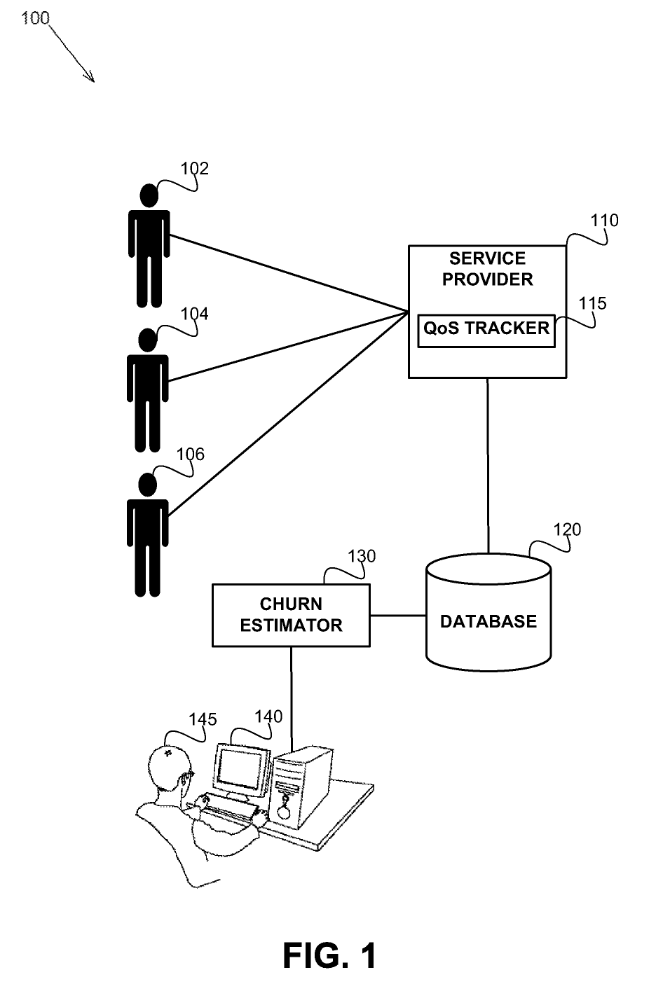

Referring now to FIG. 1 showing a computerized environment in which the disclosed subject matter is used, in accordance with some exemplary embodiments of the subject matter. A computerized environment 100 may comprise a service provider 110, such as for example a telephone company, an ISP, a mobile carrier or the like. The service provider 110 may provide service to a plurality of customers 102, 104, 106.

Various of economical models of customer relation between the customer 102 and the service provider 110 may apply. For example, the customer 102 may purchase an amount of service (such as in pre-paid phone). As another example, the customer 102 may have a contract for a timeframe with the service provider 110 in which he may or may not consume services. The “end time of service”, also referred to as waypoint, is the estimated time in which without renewing the agreement (or entering into a new agreement), the service provider 110 will stop providing the service to the customer 102. For example, in case of a predetermined timeframe, the date in which the agreement ends is the “end time of service”. As another example, in case of a purchase of an amount of service, the estimated time may be calculated based on estimated rate of consumption of the service by the customer 102 and based on the reminder of service not yet consumed by the customer 102. For example, in case the customer 102 consumes in average twenty minutes of call time a day and the customer 102 has a balance of 150 minutes left in his account, the “end time of service” may be estimated to be in about seven days.

A QoS tracker 115 may track attributes associated with the QoS of the service provided by the service provider 110 to each customer. For example, in case of a telecommunication service provider, a Call Completion Code (CCC) may be determined. The CCC may be associated with a call involving a customer. The CCC may indicate if the call terminated normally. A call may be deemed as terminated normally in case the termination is not due to the service provider 110. As an example, a call to a busy number may be considered a call that terminated normally. As another example, a call that was terminated because of low reception may be considered a call that terminated in an abnormal manner. For example, in case of a data service provider, a provided bandwidth to the customer may be tracked. As another example, in case of a retail service provider, a number of missed service events, such as for example failure to deliver a package, or to provide adequate service levels, may be tracked. In some exemplary embodiments, the QoS tracker 115 may track the attributes for other purposes. For example, some service providers may store Call Detail Records (CDR), which may include the attributes tracked by the QoS tracker.

The QoS tracker 115 may store data in a database 120. The database 120 may be stored in a storage device, such as a storage server, Tape, hard disk, Flash memory, or the like. The database 120 may be maintained for the purposes of the disclosed subject matter only, or may be maintained for additional purposes such as for example for billing purposes.

A churn estimator 130 may be configured to utilize the data stored in the database 120 to determine a churn possibility of a customer, such as 102. In some exemplary embodiments, a churn possibility is a likelihood, such as for example expressed by probability, that the customer will not continue to consume the service provided by the service provider 110 after the end time of service. The churn estimator 130 may be configured to utilize machine learning methods to utilize historic data relevant to churn and QoS provided to customers that churned in opposed to QoS provided to customers that did not churn at the end time of service.

In some exemplary embodiments, the churn estimator 130 may provide output to a user 145, such as a customer relations personnel, customer retention personnel or the like, using a man-machine interface 140. The user 145 may contact the customer 102 based on the churn possibility determined by the churn estimator 130 and provide the customer 102 with an offer. In case of a customer 102 that is “at risk” of churning, the offer may include a discount, a benefit, or the like. In some exemplary embodiments, the offer may be generated by a computerized apparatus and suggested to the user 145 who may or may not act upon the suggestion. In some exemplary embodiments, the offer may be automatically presented to the customer 102 without an interference of the user 145. In some exemplary embodiments, the churn estimator 130 may be configured to suggest to the user 145, a preferable time to contact the customer 102, such as in a week in which the QoS provided to the customer 102 is relatively high, following a series of days within which the QoS was sufficiently high (above a threshold) and are within a range (e.g., a month) to the end of service time or the like.

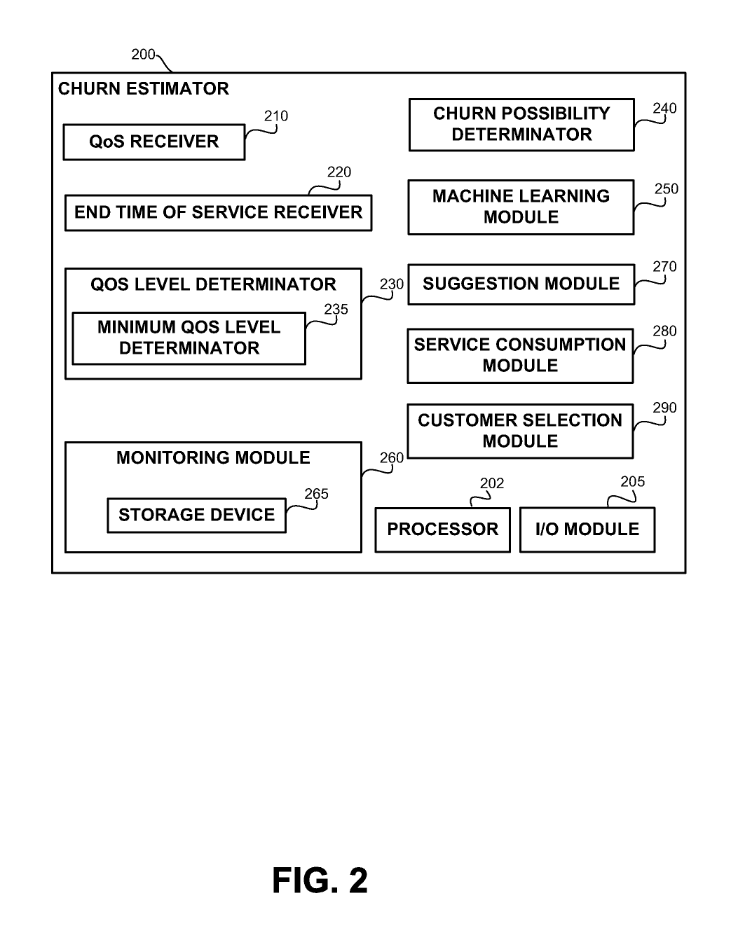

Referring now to FIG. 2 showing a churn estimator in accordance with some exemplary embodiments of the disclosed subject matter. A churn estimator 200, such as 130 of FIG. 1, may be configured to estimate churn possibility.

In some exemplary embodiments, a QoS receiver 210 may be configured to receive indications useful for determining QoS. In some exemplary embodiments, the QoS receiver 210 may receive QoS levels in different times. In some exemplary embodiments, the QoS receiver 210 may receive attributes indicative of QoS level and determine the QoS level based upon the attributes. The QoS receiver 210 may utilize an I/O module 205.

In some exemplary embodiments, QoS level determinator 230 may be configured to determine a QoS level provided to a customer during a timeframe based on the indications received by the QoS receiver 210. The timeframe may be, for example, a week, a month or the like. The QoS level determinator 230 may for example determine a QoS level based on a minimal/maximal QoS level provided to the customer during the timeframe, based on an average, median QoS level provided to the customer during the timeframe, based on a slop in a QoS level during the timeframe or between the timeframe and a previous timeframe, or the like. It will be noted that a QoS of the service may be provided in respect to units of time, such as days, hours or the like. A QoS level determined by the QoS level determinator 230 may be based upon one or more QoS associated with units of time within the timeframe. For example, in case a ten percent (10%) of calls made by the customer during a first day were terminated abnormally, ten percent (10%) of calls made by the customer during a second day were terminated abnormally, twenty percent (20%) of calls made by the customer during a third day were terminated abnormally, and five percent (5%) of calls made by the customer during a fourth day were terminated abnormally, a QoS level for a timeframe of four days may be determined such as for example as the minimal QoS provided (e.g., 20%), an average QoS provided (e.g., 11.25%) or the like. In some exemplary embodiments, a minimum QoS level determinator 235 may be utilized to determine a minimal QoS during the timeframe. In some exemplary embodiments, the QoS level for a timeframe of one day may be determined based on a fraction of abnormally terminated calls in a day.

In some exemplary embodiments, an end time of service receiver 220 may be configured to receive indications useful for determining end time of service associated with a customer. In some exemplary embodiments, the indications may be the end time of service itself. In some exemplary embodiments, the indications may be useful in calculating an estimated end time of service, such as for example the case with pre-paid services, which are traditionally not associated with an end time. In some exemplary embodiments, the end time of service may be an amount of time left until the waypoint. For example, in case the time in which the contract between the customer and the service provider expires is on Jun. 10, 2010, the end time of service on Jun. 7, 2010 may be three days, minus three days, or the like. In some exemplary embodiments, the end time of service receiver 220 may comprise a clock (not shown) utilized to indicate a current time. The end time of service receiver 220 may utilize an I/O module 205.

In some exemplary embodiments, a service consumption module 280 may be configured to determine, based on usage history of the customer, an estimated rate of consumption of service by the customer. The end time of service receiver 220 may utilize the estimated rate of consumption and an indication of an amount of service consumption units remainder associated with the customer in order to determine an estimated waypoint.

In some exemplary embodiments, a churn possibility determinator 240 may be configured to determine a possibility of churn of a customer based the QoS level determined by the QoS level determinator 230 and based upon the time that is left until the end time of service received by the end time of service receiver 220. The churn possibility determinator 240 may utilize predetermined thresholds to determine churn possibility. In some cases, thresholds may be manually determined based on prior data. The churn possibility determinator 240 may utilize a machine learning module 250 to determine churn possibility based on prior data. In some exemplary embodiments, the churn possibility determinator 240 may be configured to divide customers into two or more groups, such as for example: churners and non-churners, where the churner group comprises customers that are likely to churn whereas the non-churners group comprises customers that are likely to be retained. In some exemplary embodiments, the churners group may be further divided based upon a probability of churn, such as for example low probability, medium probability and high probability.

In some exemplary embodiments, a machine learning module 250 may be configured to perform a machine learning method based on historic data to determine, based on current data, churn possibility. The machine learning method may be, for example, decision tree learning, association rule learning, clustering, or the like. In some exemplary embodiments, the machine learning module 250 may perform an initialization phase, also referred to as training, based on historic data. The historic data may comprise data indicative of QoS levels provided to various customers, one or more end time of service associated with each customer, and whether each customer churned or was retained. For example, historic data may comprise data for the customer 102 showing that the customer 102 had five waypoints during his relations with the service provider, during the four first waypoints the customer 102 has renewed (with or without modifications to the terms) his agreement with the service provider (i.e., the customer 102 was retained as a customer), and in the fifth waypoint the customer churned. It will be noted that the term historic data refers to past data as opposed to current data using which prediction is performed. The historic data may be provided by another entity different than the service provider. For example, historic data of another service provider may be utilized. In some exemplary embodiments, the historic data may be associated with a service similar to that provided by the service provider, which was provided to customers similar to the customers of the service provider, such as for example from the same country, state, city, having similar income, similar education, or other socioeconomical attributes or the like.

In some exemplary embodiments, the churn estimator 200 may further comprise a monitoring module 260, such as for example QoS tracker 115 of FIG. 1, configured to monitor QoS levels provided in a time unit to customers. In some exemplary embodiments, the monitoring module 260 may comprise a storage device 265 utilized to retain a database of QoS levels, such as for example 120 of FIG. 1.

In some exemplary embodiments, a suggestion module 270 may be configured to determine a suggested offer to the customer based on the churn possibility determinator. The suggested offer may include a discount, a reduced price, a benefit, or the like. The suggested offer may be used and offered to the customer in order to increase possibility of retention.

In some exemplary embodiments, a customer selection module 290 may be utilized to select a customer from a plurality of customers. The selected customers may be provided with a suggested offer determined by the suggestion module 270. For example, the customer selection module 290 may select customers nearing their waypoint and having a low probability of churn even though they are not in their waypoint. In this example, a customer that has a month until his waypoint may be contacted in case his likelihood of retention is high. If he his likely to churn as the QoS provided to him lately was relatively low, the customer may be approached two weeks later.

In some exemplary embodiments of the disclosed subject matter, the churn estimator 200 may comprise an Input/Output (I/O) module 205. The I/O module 205 may be utilized to provide an output to a user, such as 145 of FIG. 1.

In some exemplary embodiments, the churn estimator 200 may comprise a processor 202. The processor 202 may be a Central Processing Unit (CPU), a microprocessor, an electronic circuit, an Integrated Circuit (IC) or the like. The processor 202 may be utilized to perform computations required by the churn estimator 200 or any of it subcomponents.

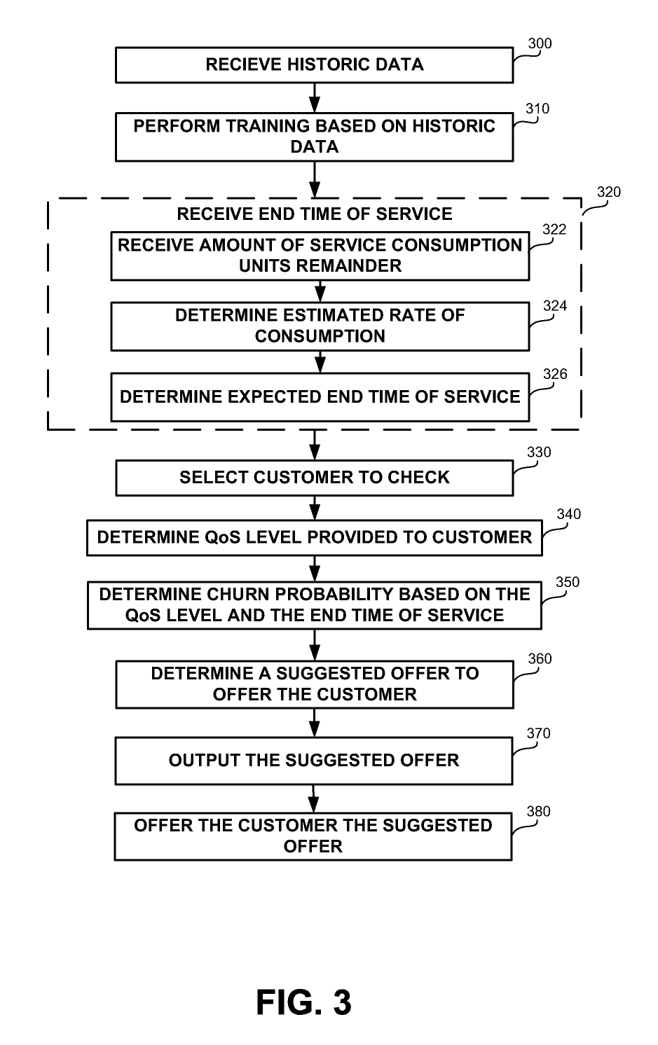

Referring now to FIG. 3 showing a flowchart diagram of a method in accordance with some exemplary embodiments of the disclosed subject matter.

In step 300, historic data may be obtained. The historic data may be obtained by a machine learning module, such as 250 of FIG. 2.

In step 310, training may be performed based upon the historic data. The training may be performed by the machine learning module.

In step 320, a waypoint (or indication thereof) may be received. The waypoint may be received by an end time of service receiver 220.

In some exemplary embodiments, step 320 may comprise receiving amount of service consumption units remainder associated with a customer (step 322), determining estimated rate of consumption (step 324) and determining expected end time of service (step 326). The rate of consumption may be determined by a service consumption module, such as 280 of FIG. 2. In some exemplary embodiments, step 320 may be performed in respect to a plurality of customers.

In step 330, a customer to be checked may be selected. The selection may be performed by a customer selection module, such as 290 of FIG. 2, based upon a distance from a respective waypoint. For example, only customers that are within two months from their respective waypoints may be selected. In some exemplary embodiments, an additional or an alternative selection may be performed prior to determination of a suggested offer.

In step 340, a QoS level provided to the customer during a timeframe may be determined. The QoS level may be determined by a QoS level determinator, such as 230 of FIG. 2. The QoS level may be determined based on QoS in different time units within the timeframe, such as received by the QoS receiver 210 of FIG. 2.

In step 350, a churn probability may be determined. The determination may be performed based on the QoS level and the end time of service. The churn probability may be determined by a churn possibility determinator, such as 240 of FIG. 2, which may utilize machine learning methods.

Based upon the churn probability determined in step 350, a suggested offer to the customer may be determined in step 360. The suggested offer may be determined by a suggestion module, such as 270 of FIG. 2.

In step 370, the suggested offer may be outputted to a user. The suggested offer may be outputted by an output module such as 205 of FIG. 2.

In step 380, the offer may be offered to the customer. The offer may be offered by a user, such as 145 of FIG. 1. In some exemplary embodiments, the offer may be automatically offered to the customer, such as by sending the customer an email, a letter, a text message or the like.

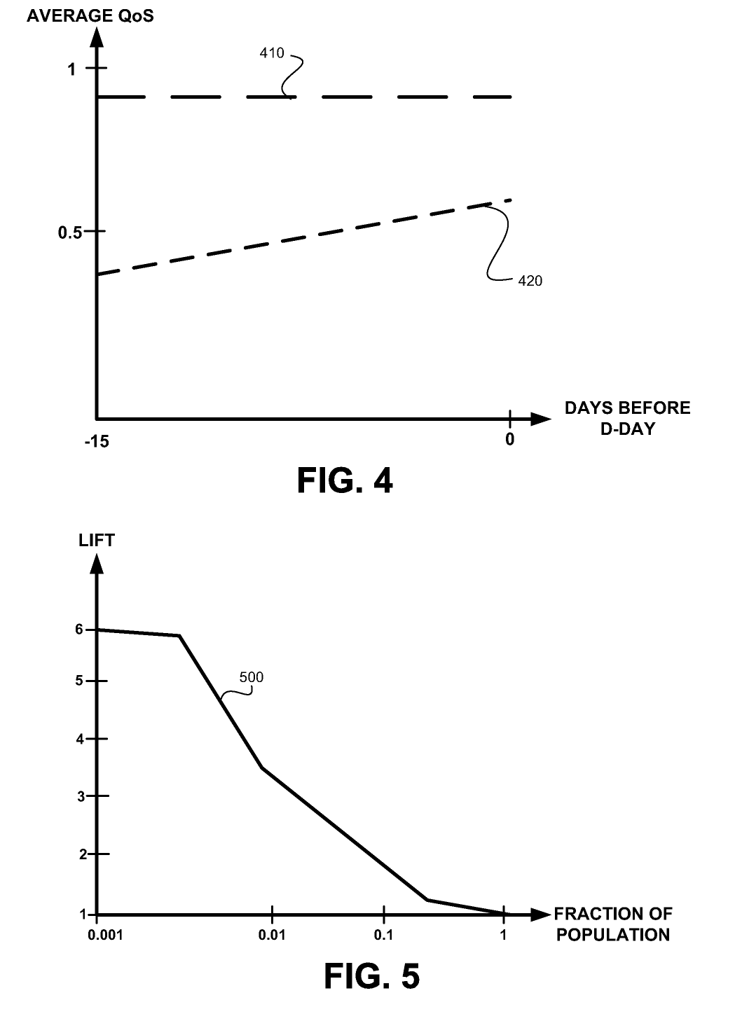

Referring now to FIG. 4 showing two curves between days before waypoint and average QoS provided to customers, in accordance with the disclosed subject matter.

Curves 410, 420 show a relationship between time left until waypoint (referred to as D-day, and measured in days) and average QoS level of the customers. The average QoS level is an average of QoS level provided to customers. The curve 420 shows the average QoS level provided to customers that churned in the D-Day. The curve 410 is associated with customers that did not churn. The curves 410 and 420 may be determined based on historic data. As can be seen from the curves 410, 420 customers are more sensitive to QoS levels near the day of the churn; and the QoS level that is needed to make a person stay is consistently higher than that which can be causes churn.

FIG. 4 may be used to show that when population of customers that churned and matching population of customers that did not churn are compared based on worst QoS levels provided to the customers, a service level gap may be identified (the gap between the curves 410 and 420).

In some exemplary embodiments, the curve 410 and/or 420 may be determined using a regression based on discrete values. For example, an average QoS value (Y-axis) for each day (X-axis) may be determined and a regression may be performed to provide for a continuous curve, such as a linear curve.

Referring now to FIG. 5 showing a curve exemplifying a lift in identifying customers that are about to churn using the disclosed subject matter. By utilizing the disclosed subject matter and selecting a portion of the customers based on evaluated churn possibility, a lift in identifying customers that eventually churned may be gained. For example, the curve 500 shows that in one exemplary embodiment, when a 0.1% of the customers are selected, a first group of customers that is selected based on the top 0.1% customers having a highest probability to churn, contains about six times more customers that will actually churn in comparison to a second group of customers that are selected randomly. In a fraction of 1% of the customers, a lift of about three times is gained using the disclosed subject matter.

In some exemplary embodiments, customers retention may be improved by computing daily QoS in a timeframe for each customer. In some cases, only customers of pre-paid services may be monitored. In case a customer is nearing a waypoint (e..g, day of contract renewal, day of card recharge or the like), a likelihood of churn may be estimated based on a service gap computed based on historic data, such as shown in FIG. 4. In some exemplary embodiments, customers may be considered to be nearing their waypoint in case the waypoint is occurring no longer than a predetermined time, such as a week, a month, two months or the like. In case the customer is assigned with a churn possibility above a predetermined threshold, a reduced price or similar advantageous offer, may be offered to the customer. In some exemplary embodiments, the reduction in price (or value of other advantageous aspects of the offer) may be determined based on a distance from the curve 410 of FIG. 4. As the QoS level provided to the customer is lower than the respective QoS level in the curve 410, a better offer may be offered to the customer.

In some exemplary embodiments, prior art churn prediction methods may be augmented in accordance with the disclosed subject matter with features based on QoS.

In some exemplary embodiments, a recommendation system may relay on QoS indicators, and optionally other indicators such as those known to a person skilled in the art, and be configured to recommend offers for customers to their next period (i.e., after their waypoint). Each customer may be tailored a different offer based on QoS levels he was provided in a current period (i.e., before the waypoint).

In some exemplary embodiments, in case the customer is predicated to renew his agreement with the service provider, a suggestion module, such as 270 of FIG. 2, may determine and suggest a time to make the offer to the customer. The timing of making the offer may be determined such to coincide with the best possible QoS indicator associated with the customer, so as to decrease the cost of the offer. For example, in case the QoS level provided to the customer in a first day is relatively low, the service provider may postpone the time to make the offer.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computerized apparatus for estimating churn possibility, the computerized apparatus having a processor, the computerized apparatus comprising:
a first receiver configured to receive an indication of Quality of Service based on a service provided to a customer by a service provider;
a second receiver configured to receive an indication of a time in which the customer is estimated to either continue or discontinue receiving the service from the service provider;
a Quality of Service level determinator configured to determine a Quality of Service level provided to the customer in a timeframe based on the indication received by said first receiver;
a churn possibility determinator configured to determine a probability of churn associated with the customer based on the Quality of Service level determined by said Quality of Service level determinator and based on the time received by said second receiver; and
an output module configured to provide an indication of the probability of churn determined by said churn possibility determinator.

2. The computerized apparatus of claim 1, wherein the Quality of Service is selected from a group consisting of a number of partially-provided services, a percentage of partially-provided services and an average provided bandwidth.

3. The computerized apparatus of claim 1 further comprises a machine learning module configured to utilize historic data to predict churn based on current data, the historic data comprises:
an indication of Quality of Service levels provided to customers over time;
an indication of either churn or renewal operations of the customers; and
an indication of times in which the customers were estimated to either continue or discontinue receiving the service from the service provider; and
wherein said churn possibility determinator utilizes said machine learning module.

4. The computerized apparatus of claim 1 further comprises a monitoring module, wherein said monitoring module is configured to monitor Quality of Service levels provided to the customer; and wherein said first receiver is configured to receive the indication of Quality of Service from the monitoring module.

5. The computerized apparatus of claim 4, wherein said monitoring module further comprises a storage device for retaining monitored data.

6. The computerizes apparatus of claim 1, wherein said Quality of Service level determinator comprises a minimum Quality of Service level determinator configured to select a minimal Quality of Service level from a plurality of Quality of Service levels.

7. The computerized apparatus of claim 1 further comprises a suggestion module configured to determine a suggested offer to the customer, the suggested offer is determined based on the probability of churn determined by said churn possibility determinator; and wherein said output module is further configured to output the suggested offer.

8. The computerized apparatus of claim 7, wherein the suggested offer comprises a suggested price, wherein said suggestion module is configured to determine a lower suggested price to a higher probability of churn in respect to probability of churn above a threshold.

9. The computerized apparatus of claim 1, wherein the time in which the customer is estimated to either continue or discontinue receiving service from the service provider is an end of contract date.

10. The computerized apparatus of claim 1 further comprises:
a service consumption module configured to determine, based on usage history of the customer, an estimated rate of consumption of service by the customer; and
wherein said second receiver is configured to calculate the time based on:
the estimated rate of consumption of service; and
an amount of service consumption units remainder associated with the customer.

11. The computerized apparatus of claim 10, wherein the service consumption unit is selected from a group consisting of bandwidth, connect time and call time.

12. The computerized apparatus of claim 10 further comprises a customer selection module configured to select the customer from a plurality of customers, said customer selection module is configured to select the customer based on the time.

13. A computer-implemented method for estimating churn possibility, the method comprising:
receiving an indication of Quality of Service based on a service provided to a customer by a service provider;
receiving an indication of a time in which the customer is estimated to either continue or discontinue receiving the service from the service provider;
determining a Quality of Service level provided to the customer in a timeframe based on the indication of Quality of Service;
determining a probability of churn associated with the customer based on the Quality of Service level and based on the time in which the customer is estimated to either continue or discontinue receiving the service from the service provider; and
outputting an indication of the probability of churn.

14. The method of claim 13 further comprising:
analyzing historic data of customers, the historic data comprises:
an indication of Quality of Service levels provided to customers over time;
an indication of either churn or renewal operations of the customers; and
an indication of times in which the customers were estimated to either continue or discontinue receiving service from the service provider; and
wherein said determining the probability of churn comprises utilizing a machine learning method based on the analysis of the historic data.

15. The method of claim 13 further comprises monitoring Quality of Service levels provided to the customer during the timeframe; and wherein said determining the Quality of Service level provided to the customer in the timeframe comprises determining a minimal Quality of Service level provided to the customer during the timeframe.

16. The method of claim 13 further comprises, based upon the indication of the probability of churn, determining an offer to the customer; and offering the offer to the customer.

17. The method of claim 16, wherein said determining the offer comprises: automatically determining a suggested offer; and determining to use the suggested offer as the offer.

18. The method of claim 13, wherein the indication of the time in which the customer is estimated to either continue or discontinue receiving service from the service provider is an amount of service consumption units remainder associated with the customer; said method further comprises:
determining, based on usage history of the customer, an estimated rate of consumption of service by the customer; and
calculating the time in which the customer is estimated to either continue or discontinue receiving service from the service provider based on the amount of service consumption units remainder and the estimated rate of consumption of service.

19. The method of claim 13 further comprises:
selecting the customer from a plurality of customers, wherein said selecting the customer is performed based on the time calculated in said calculating the time in which the customer is estimated to either continue or discontinue receiving service from the service provider.

20. A computer program product for estimating churn possibility, the product comprising:
a computer readable medium;
a first program instruction for receiving an indication of Quality of Service based on a service provided to a customer by a service provider;
a second program instruction for receiving an indication of a time in which the customer is estimated to either continue or discontinue receiving the service from the service provider;
a third program instruction for determining a Quality of Service level provided to the customer in a timeframe based on the indication of Quality of Service;
a fourth program instruction for determining a probability of churn associated with the customer based on the Quality of Service level and based on the time in which the customer is estimated to either continue or discontinue receiving the service from the service provider;
a fifth program instruction for outputting an indication of the probability of churn; and
wherein said first, second, third, fourth and fifth program instructions are stored on said computer readable medium.
